(19) United States
(12) Patent Application Publication
(10) Pub. No.: US 2015/0244886 A1
(43) Pub. Date: Aug. 27, 2015

(54) PERSONAL DIGITAL ASSISTANT APPARATUS, DISPLAY METHOD, AND RECORDING MEDIUM FOR DISPLAYING ABNORMAL STATUS OF IMAGE FORMING APPARATUS

(71) Applicant: KYOCERA Document Solutions Inc., Osaka (JP)

(72) Inventor: Takashi TAMURA, Osaka (JP)

(73) Assignee: KYOCERA Document Solutions Inc., Osaka (JP)

(21) Appl. No.: 14/633,669

(22) Filed: Feb. 27, 2015

(30) Foreign Application Priority Data
Feb. 27, 2014 (JP) 2014036272

(51) Int. Cl. H04N 1/00; H04N 1/32

(52) U.S. Cl. CPC H04N 1/00477; H04N 1/00129; H04N 1/00408; H04N 1/32625; H04N 1/32662

(57) ABSTRACT

Provided is a Personal Digital Assistant (PDA) apparatus that provides an adequate display according to a positional relation between a user and an image forming apparatus. A CPU of the PDA apparatus acquires positional information of the image forming apparatus and calculates a distance between the PDA apparatus and the image forming apparatus based on the acquired positional information and positional information of the PDA apparatus. Then, the CPU determines whether the calculated distance is equal to or greater than a threshold. If the determination is Yes, the CPU displays an outline of an abnormal status of the image forming apparatus in text on a display panel. If the determination is No, CPU displays how to solve the abnormal status in the display panel.

### INCORPORATION BY REFERENCE

This application is based on and claims the benefit of priority from Japanese Patent Application No. 2014-036272 filed on Feb. 27, 2014, the contents of which are hereby incorporated by reference.

### BACKGROUND

The present disclosure relates to a personal digital assistant apparatus, a display method and a recording medium for displaying an abnormal status when some abnormality occurs in an image forming apparatus.

According to an example of a typical system, an image forming apparatus sends information defining an operational screen for using the functions of the information terminal apparatus to a personal digital assistant apparatus. The information terminal apparatus creates an operational screen according to the received screen definition information and transmits an execution request to the image forming apparatus according to an operation that is performed through the operational screen.

### SUMMARY

A personal digital assistant apparatus according to the present disclosure includes a distance calculating part, a distance discriminating part, and an abnormal-status display part. The distance calculating part acquires positional information of an image forming apparatus, and calculates a distance from the image forming apparatus. The distance discriminating part discriminates whether the distance calculated by the distance calculating part is equal to or greater than a threshold. The abnormal-status display part displays an outline of an abnormal status of the image forming apparatus when the distance calculated by the distance calculating part is discriminated to be equal to or greater than the threshold, and displays how to solve the abnormal status of the image forming apparatus when the distance calculated is discriminated to be smaller than the threshold.

Further, an abnormal-status displaying method for an image forming apparatus includes a positional-information acquisition step, a distance calculation step, a distance discrimination step, an outline display step, and a details display step. In the positional-information acquisition step, positional information of the image forming apparatus is acquired. In the distance calculation step, a distance from the image forming apparatus to a personal digital assistant apparatus is calculated based on the positional information acquired in the positional-information acquisition step and positional information of the personal digital assistant apparatus. In the distance discrimination step, it is discriminated whether the distance calculated in the distance calculation step is equal to or greater than a threshold. In the outline display step, an outline of an abnormal status of the image forming apparatus is displayed on a screen of the personal digital assistant apparatus when the distance calculated in the distance calculation step is discriminated to be equal to or greater than the threshold. In the details display step, how to solve the abnormal status of the image forming apparatus is displayed on the screen of the personal digital assistant apparatus when the distance calculated in the distance discrimination step is discriminated to be smaller than the threshold.

A non-transitory recording medium according to the present disclosure having recorded therein a program for allowing a computer to function as a personal digital assistant apparatus including a distance calculating part, a distance discriminating part, and an abnormal-status display part. The distance calculating part acquires positional information of an image forming apparatus, and calculates a distance from the image forming apparatus. The distance discriminating part discriminates whether the distance calculated by the distance calculating part is equal to or greater than a threshold. The abnormal-status display part displays an outline of an abnormal status of the image forming apparatus when the distance calculated by the distance calculating part is discriminated to be equal to or greater than the threshold, and displays how to solve the abnormal status of the image forming apparatus when the distance calculated is discriminated to be smaller than the threshold.

### BRIEF DESCRIPTION OF THE DRAWINGS

FIG. 1 is a schematic view illustrating an image forming system according to an embodiment of the present disclosure.

FIG. 2 is a schematic view illustrating the configuration of the image forming apparatus in FIG. 1.

FIG. 3 is a schematic view illustrating the circuit configuration of the image forming apparatus in FIG. 1.

FIG. 4 is a schematic circuit diagram illustrating the configuration of a personal digital assistant apparatus in FIG. 1.

FIG. 5 is a flowchart of an abnormal-status display process of the image forming apparatus that is performed by the personal digital assistant apparatus in FIG. 2.

FIG. 6A is a diagram showing a screen to be displayed on a result display panel in the abnormal-status display process in FIG. 5.

FIG. 6B is a diagram showing another screen to be displayed on the result display panel in the abnormal-status display process in FIG. 5.

FIG. 7A is a diagram showing a different screen to be displayed on the result display panel in the abnormal-status display process in FIG. 5.

FIG. 7B is a diagram showing a further screen to be displayed on the result display panel in the abnormal-status display process in FIG. 5.

### DETAILED DESCRIPTION

<Embodiment>

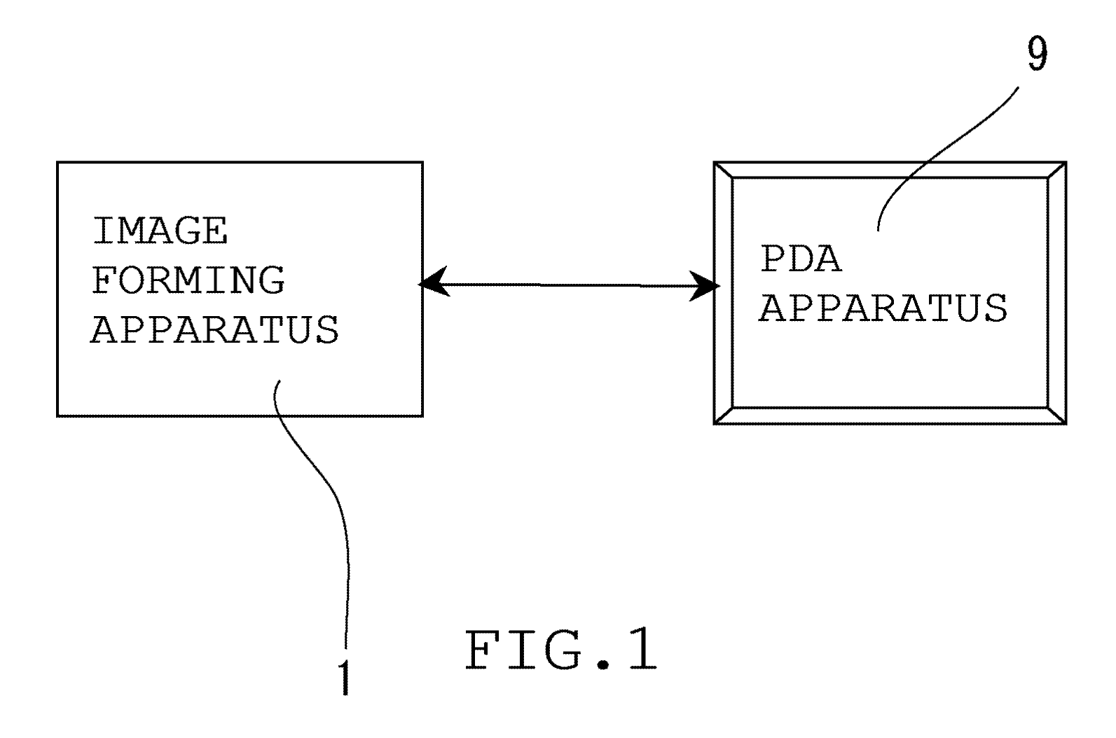

First, the configuration of a print system according to an embodiment of the present disclosure described referring to FIG. 1. FIG. 1 is a configurational diagram of the print system.

The print system includes an image forming apparatus 1 and a personal digital assistant apparatus (hereinafter also referred to as “PDA apparatus”) 9 that is communicatable with the image forming apparatus 1.

Configuration of Image Forming Apparatus 1

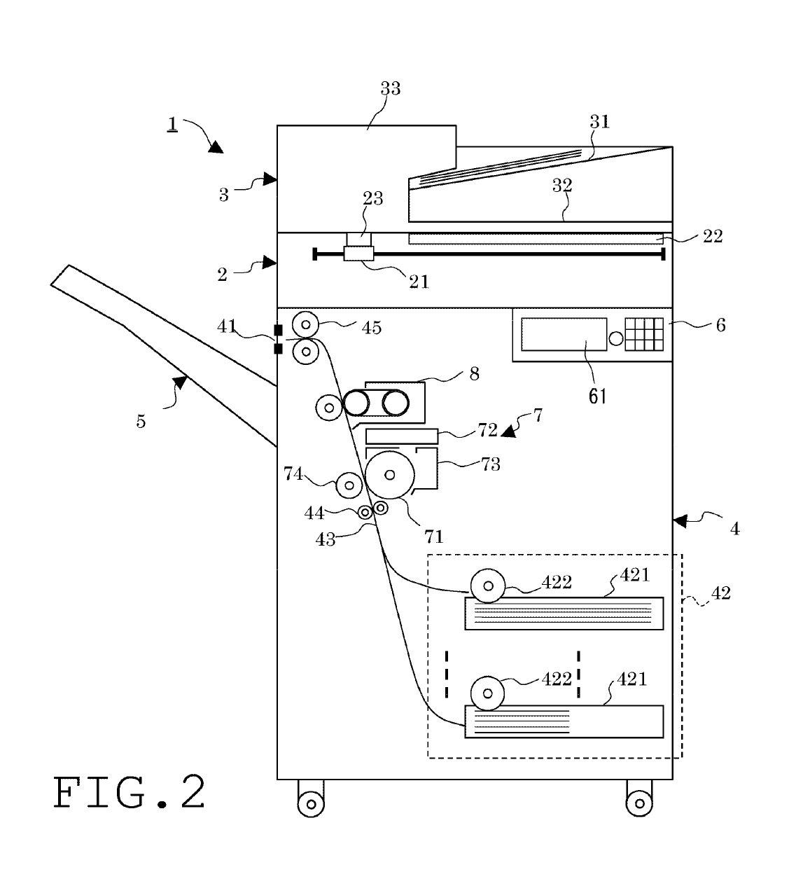

Next, the configuration of the image forming apparatus 1 according to the embodiment of the present disclosure is described in detail referring to FIG. 2.

As illustrated in FIG. 2, the image forming apparatus 1 according to the embodiment includes a manuscript reading part 2, a manuscript feeding part 3, a body part 4, a stack tray 5, and an operation panel part 6 (input part).

The manuscript reading part 2 is disposed above the body part 4, and the manuscript feeding part 3 is disposed above the manuscript reading part 2. The stack tray 5 is disposed on that side of the body part 4 where a discharge opening 41 for recording sheets is provided. The operation panel part 6 is disposed on the front side of the body part 4.

The manuscript reading part 2 includes a scanner 21, a platen glass 22, and a manuscript reading slit 23. The scanner 21 includes an exposure lamp, an imaging sensor, or the like, and is configured to be movable in the direction where the manuscript feeding part 3 carries a manuscript. The platen glass 22 is a manuscript platen made of a transparent member such as glass. The manuscript reading slit 23 has a slit formed in a direction orthogonal to the manuscript carrying direction of the manuscript feeding part 3.

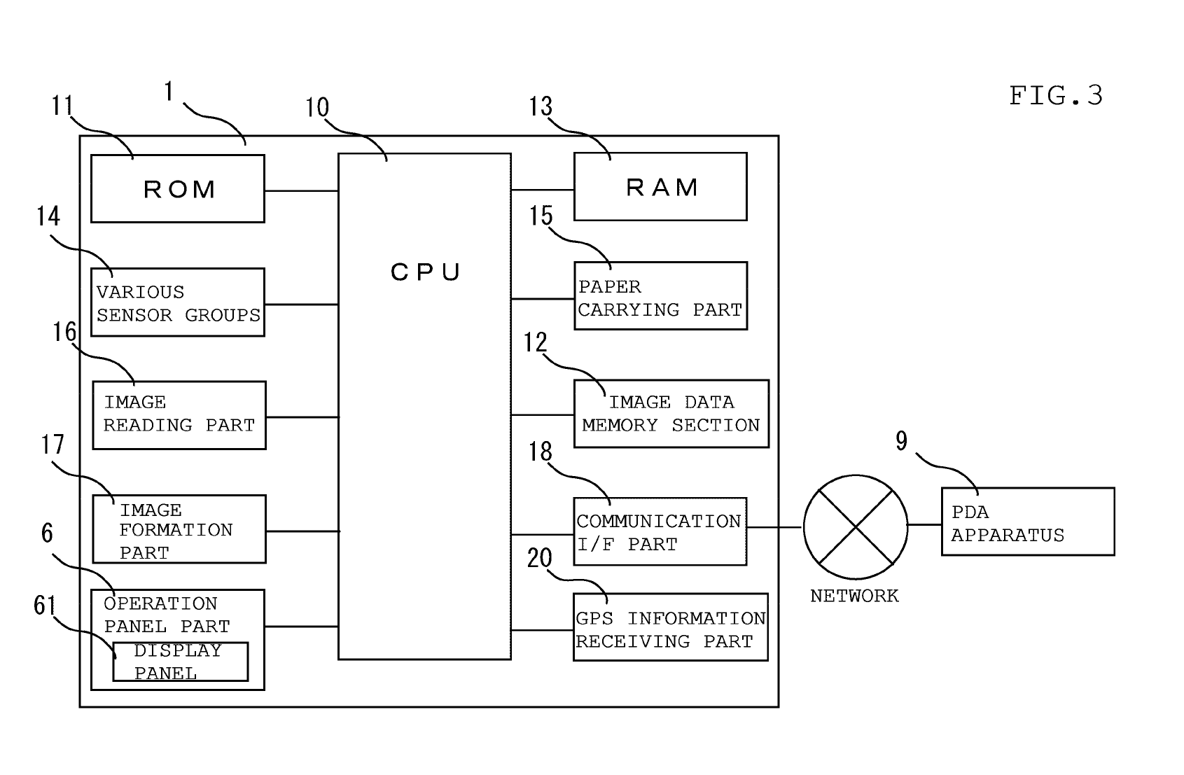

To read a manuscript placed on the platen glass 22, the scanner 21 is moved to a position facing the platen glass 22. The scanner 21 scans the manuscript placed on the platen glass 22 to acquire image data. The scanner 21 outputs the acquired image data to an image formation part 17 (FIG. 3) provided in a control circuit of the body part 4.

To read a manuscript fed by the manuscript feeding part 3, the scanner 21 is moved to a position facing the manuscript reading slit 23. The scanner 21 scans the manuscript via the manuscript reading slit 23 in synchronism with the feeding of the manuscript by the manuscript feeding part 3 to thereby acquire image data. The scanner 21 outputs the acquired image data to the image formation part 17 (FIG. 3) provided in a control circuit of the body part 4.

The manuscript feeding part 3 includes a manuscript mounting part 31, a manuscript discharge part 32, and a manuscript transport mechanism 33. A manuscript mounted on the manuscript mounting part 31 is fed out piece by piece and is transported to a position facing the manuscript reading slit 23 by the manuscript transport mechanism 33. The manuscript is then discharged to the manuscript discharge part 32. It is to be noted that the manuscript feeding part 3 may be configured to be foldable so that lifting the manuscript feeding part 3 above opens the top surface of the platen glass 22.

The body part 4 includes an image formation part 7. The body part 4 also includes a feeding part 42, a paper sheet conveying path 43, a conveying roller pair 44, and an ejection roller pair 45. The feeding part 42 includes a plurality of sheet paper cassettes 421 for retaining recording sheets different in size or direction, and a feed roller 422 that feeds the recording sheets from the sheet paper cassettes 421 one at a time to the paper sheet conveying path 43.

The feed roller 422, the conveying roller pair 44, and the ejection roller pair 45 serve as a conveyance part. The recording sheets are transported by this conveyance part. The recording sheet that is fed out onto the paper sheet conveying path 43 by the feed roller 422 is conveyed to the image formation part 7 by the conveying roller pair 44.

Then, the recording sheet on which recording is done by the image formation part 7 is ejected to the stack tray 5 by the ejection roller pair 45.

The operation panel part 6 includes a display panel 61 and an input part. The input part includes an operation-mode change button, and buttons and a touch panel or the like for giving various instructions. The operation-mode change button changes an operation mode to a start key, ten keys, copy, FAX transmission, a scanner, or the like. The buttons and the touch panel for giving various instructions serve to give instructions on printing, transmission, reception, saving, and recording. That is, the operation panel part 6 accepts instructions for various jobs that are input to the image forming apparatus 1 by a user.

The operation panel part 6 also accepts an input of an authentication, such as a password, made by the user.

The image formation part 7 includes a photo conductor drum 71, an exposure part 72, a developing part 73, a transfer part 74, and a fixing apparatus 8. The exposure part 72 is an optical unit including a laser unit, a mirror, a lens, or the like. The exposure part 72 outputs light based on image data to expose the photo conductor drum 71, thereby forming an electrostatic latent image on the top surface of the photo conductor drum 71. The developing part 73 is a developing unit that develops the electrostatic latent image on the top surface of the photo conductor drum 71 with toner. The developing part 73 forms a toner image based on the electrostatic latent image on the photo conductor drum 71.

The transfer part 74 transfers the toner image, formed on the photo conductor drum 71, onto a recording sheet. The fixing apparatus 8 heats the recording sheet having the toner image transferred thereon by the transfer part 74 to fix the toner image on the recording sheet.

Next, the circuit configuration of the image forming apparatus 1 is described.

FIG. 3 is a schematic view illustrating the circuit configuration of the image forming apparatus 1.

The image forming apparatus 1 includes a CPU 10, a ROM 11, an image data memory part 12, a RAM 13, various sensor groups 14, a paper carrying part 15, an image reading part 16, the image formation part 17, a communication interface (I/F) part 18, the operation panel part 6, and a GPS information receiving part 20. The CPU 10 controls the operation of the image forming apparatus 1. The ROM 11 stores programs and data that are used in processes to be performed by the CPU 10. The image data memory part 12 stores image data for forming an image. The RAM 13 stores other data to be used in the processes of the CPU 10.

The paper carrying part 15 operates the manuscript discharge part 32 and the manuscript transport mechanism 33 of the manuscript feeding part 3, the conveyance part of the body part 4, and the like. The various sensor groups 14 include an imaging sensor provided in the body part 4, and the input part of the operation panel part 6. The image reading part 16 operates the scanner 21 of the manuscript reading part 2. The image formation part 17 operates the image formation part 7 and the transfer part 74. The communication I/F part 18 is used in communications over a network. The GPS information receiving part 20 receives GPS information.

The CPU 10 controls the operation of the image forming apparatus 1 according to manipulation information input via the communication I/F part 18 from the PDA apparatus 9 and transmits data needed to display an abnormal-status display screen to be described later to the PDA apparatus 9 via the communication I/F part 18. Further, the CPU 10 generates positional information of the image forming apparatus 1 based on the GPS information received by the GPS information receiving part 20 and transmits the positional information to the PDA apparatus 9 in response to a request therefrom.

Then, the PDA apparatus 9 is described.

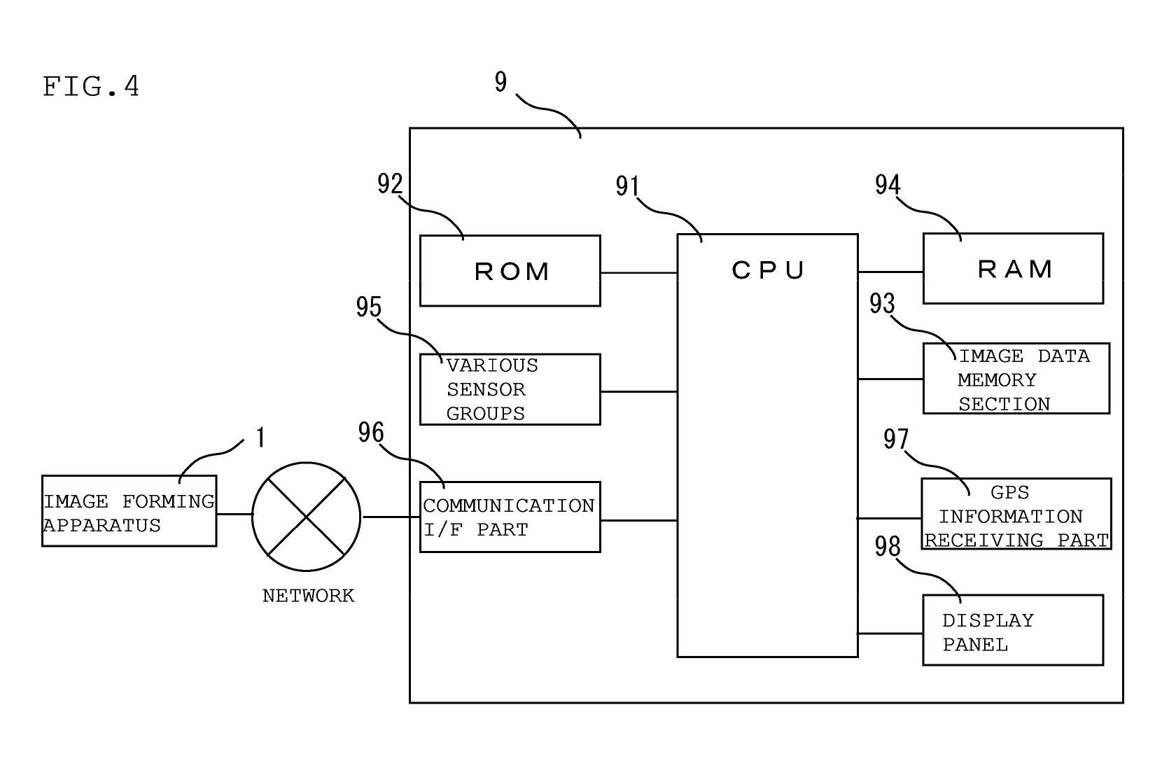

FIG. 4 is a schematic circuit diagram illustrating the circuit configuration of the PDA apparatus 9.

The PDA apparatus 9 includes a CPU 91, a ROM 92, an image data memory part 93, a RAM 94, various sensor groups 95, a communication I/F part 96, a GPS information receiving part 97, and a display panel 98. The CPU 91 controls the operation of the PDA apparatus 9. The ROM 92 stores programs and data that are used in processes to be performed by the CPU 91. The image data memory part 93 stores image data for forming an image. The RAM 94 stores other data to be used in the processes of the CPU 91.

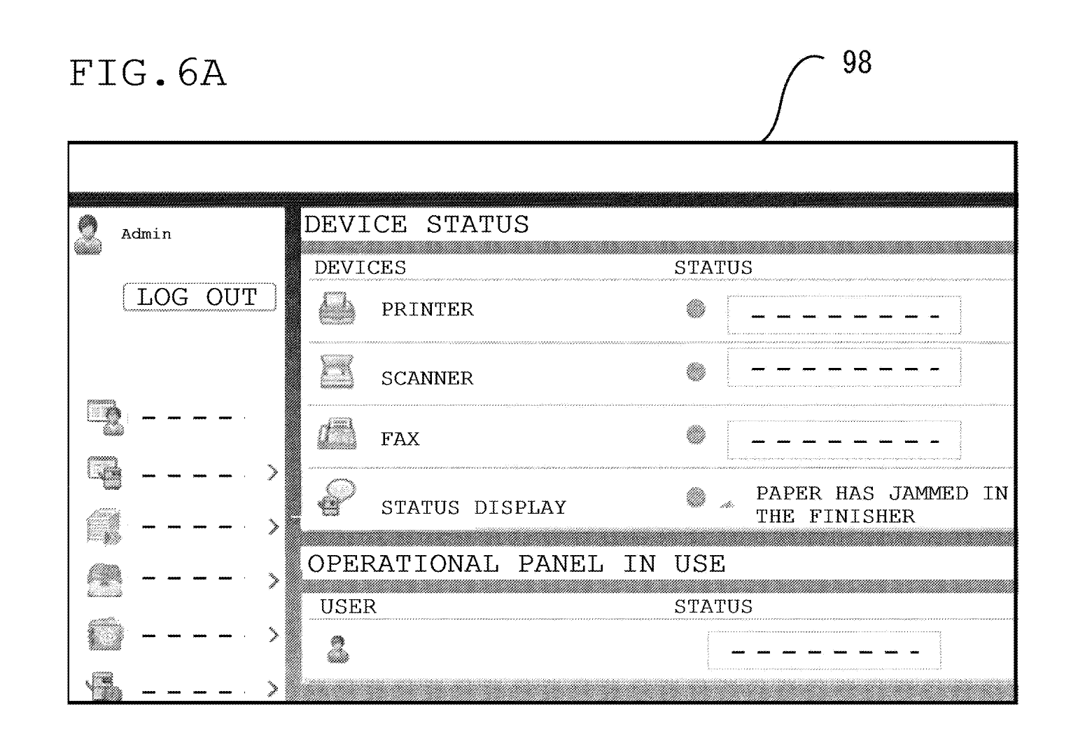

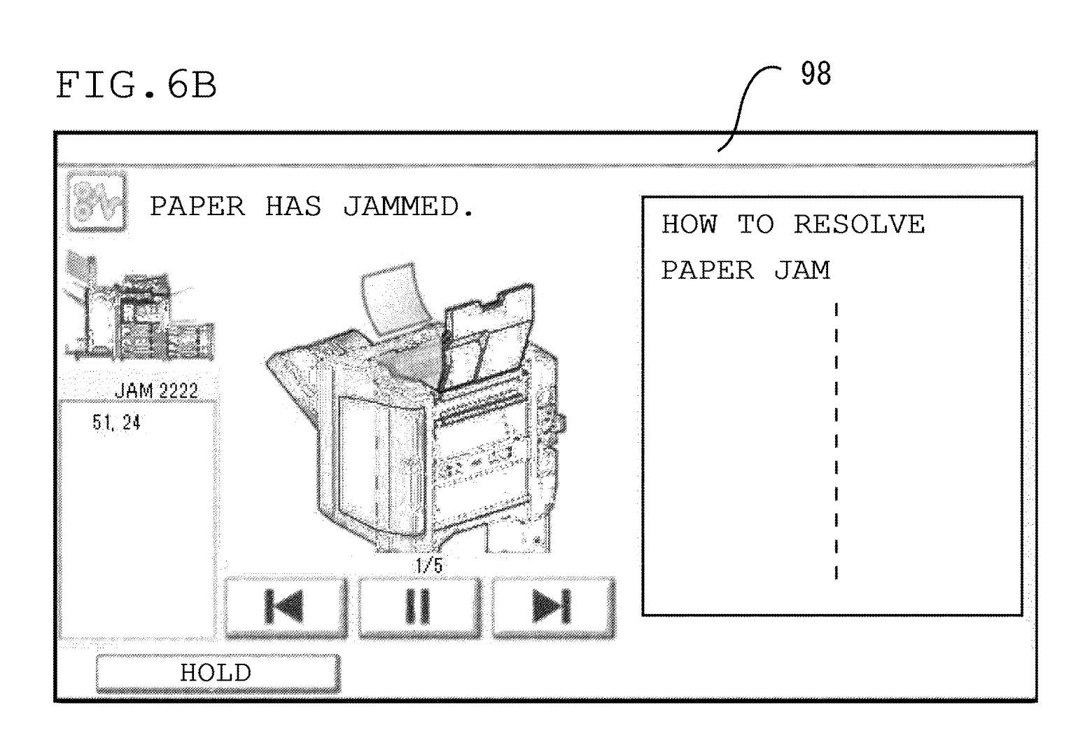

The various sensor groups 95 include a sensor that detects a manipulation performed on the display panel 98 (as refer to FIGS. 6A and 6B). The communication I/F part 96 is used in communications over a network. The GPS information receiving part 97 receives GPS information. An operational application for operating the image forming apparatus 1 in communications over a network is stored in the ROM 92.

Under control of the operational application, the CPU 91 displays data transmitted from the image forming apparatus 1 on the display panel 98 and transmits a result of an operation performed on the display panel 98 by the user to the image forming apparatus 1. Under control of the operational application, the CPU 91 also acquires GPS information via the GPS information receiving part 20 and stores positional information of the PDA apparatus 9 in the RAM 94.

Further, under control of the operational application, the CPU 91 performs an abnormal-status display process to be described later and shows, on the display panel 98 of the PDA apparatus 9, a display screen representing display contents according to the distance between the image forming apparatus 1 and the PDA apparatus 9. An abnormal-status display screen shows an abnormal status of the image forming apparatus 1.

The following describes the abnormal-status display process that is performed by the CPU 91.

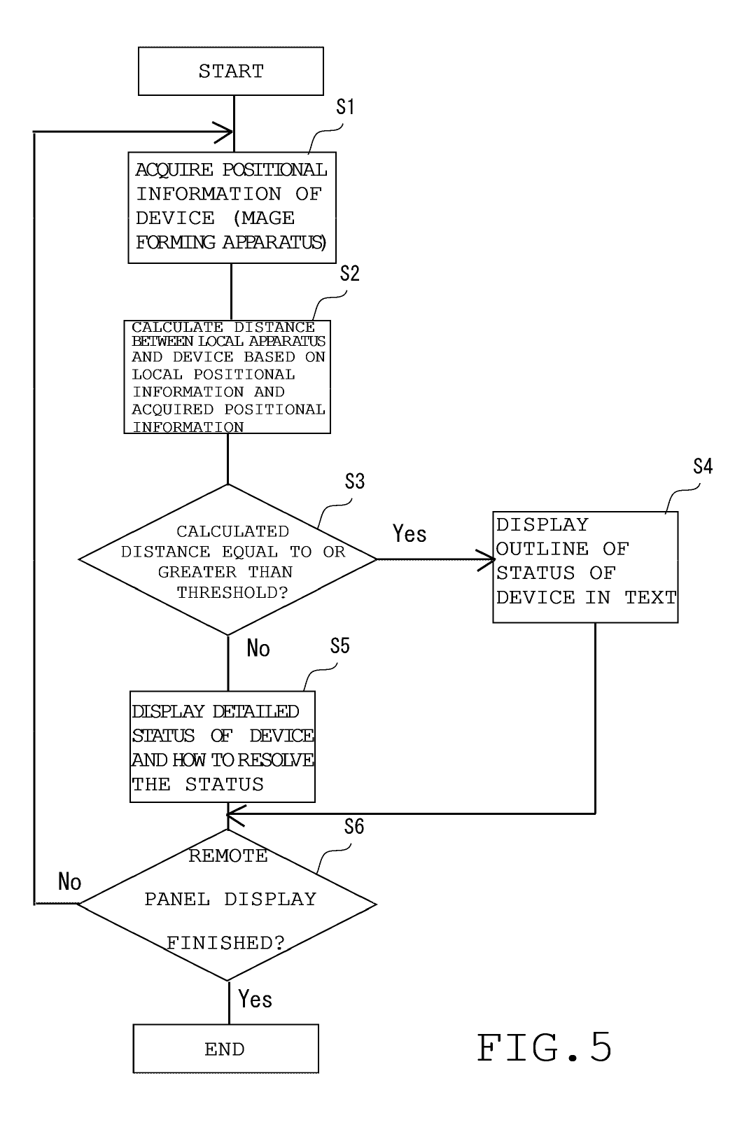

FIG. 5 is a flowchart of the abnormal-status display process.

The abnormal-status display process causes the display panel 98 to display an abnormal status of the image forming apparatus 1 when some abnormality occurs in the image forming apparatus 1. The abnormal-status display process is performed when it becomes necessary to display an abnormal status of the image forming apparatus 1 with the display panel 98 displaying a remote panel.

When some abnormality occurs in the image forming apparatus 1, the abnormality is detected. When it is necessary to solve this abnormality, the process in FIG. 5 starts.

In the abnormal-status display process, the CPU 91 acquires positional information of an apparatus (image forming apparatus 1) (S1). Subsequently, the CPU 91 calculates the distance between the image forming apparatus 1 and the PDA apparatus 9 based on positional information of the PDA apparatus 9 and the positional information of the image forming apparatus 1 acquired in S1 (S2).

Next, the CPU 91 determines whether the distance calculated in S2 is equal to or greater than a threshold (S3). When the calculated distance is equal to or greater than the threshold so that the determination in S3 is affirmative (Yes), the CPU 91 displays an outline of the abnormal status of the image forming apparatus 1 in text on the display panel 98 (S4). On the other hand, when the distance calculated in S2 is smaller than the threshold so that the determination in S3 is negative (No), the CPU 91 displays how to solve the abnormal status of the image forming apparatus 1 on the display panel 98 (S5).

After the process of S4 or S5, the CPU 91 determines whether the display panel 98 finishes displaying a remote panel (S6). When the display of the remote panel on the display panel 98 is finished so that this determination is Yes, the CPU 91 terminates the abnormal-status display process. When the display of the remote panel on the display panel 98 has not been finished so that the determination in S6 is No, the CPU 91 returns to the process of S1 to repeat the above-described abnormal-status display process.

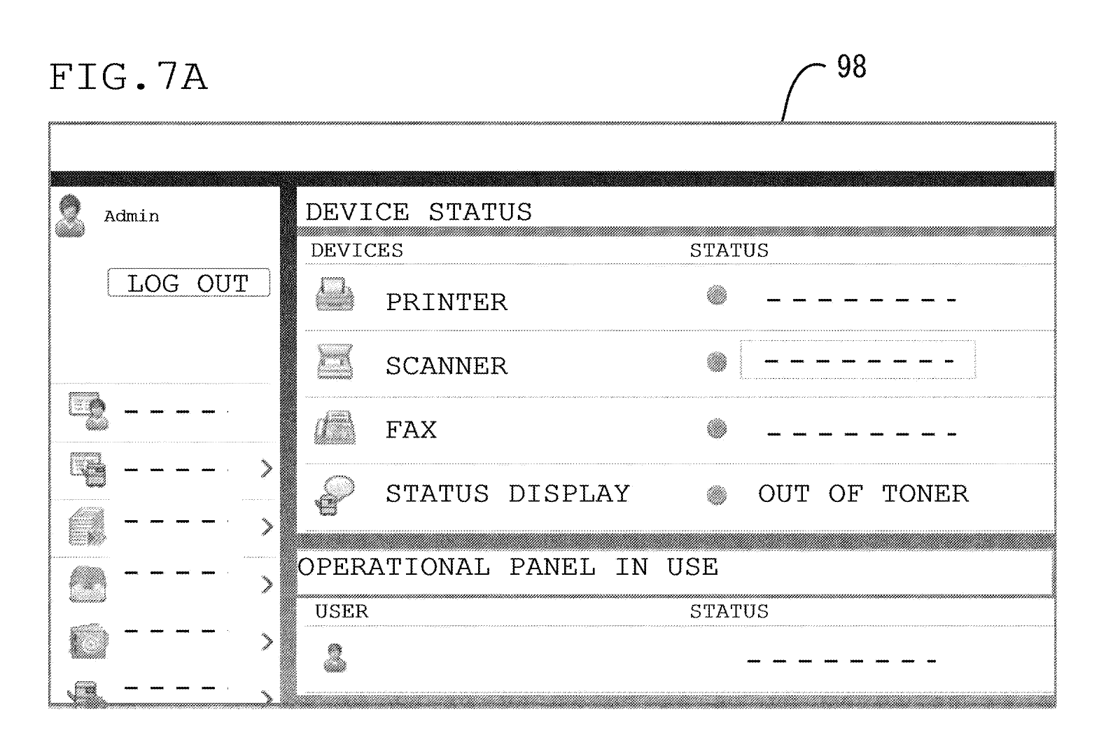

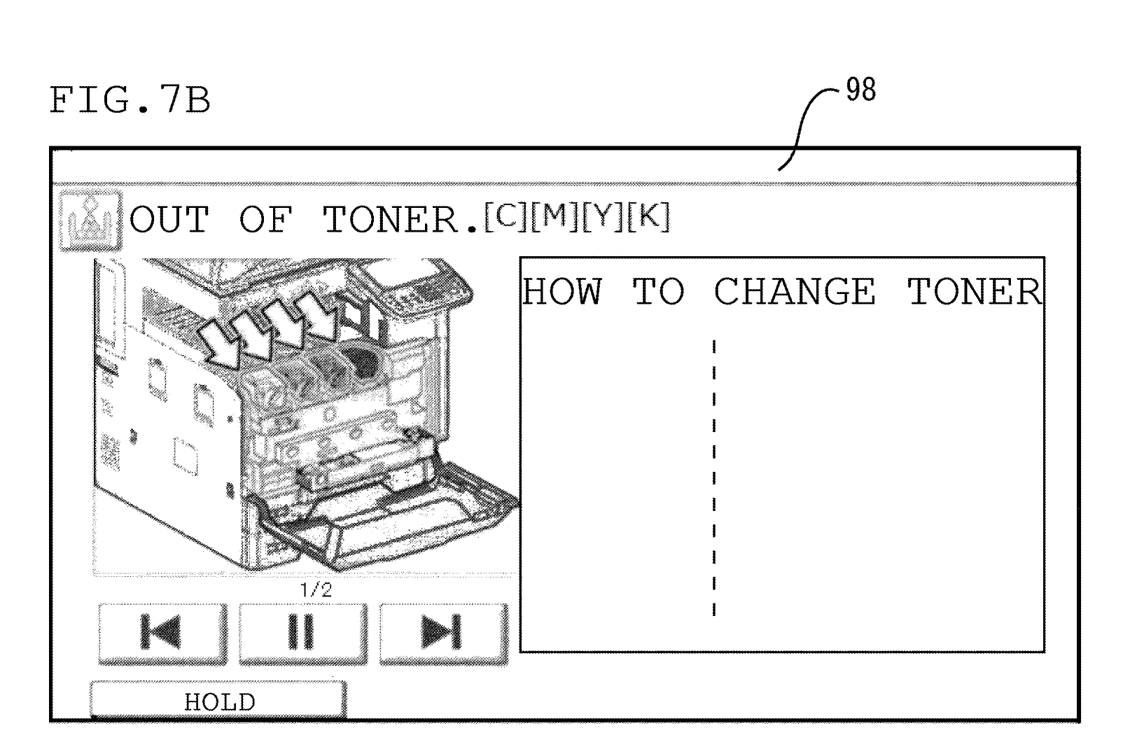

Referring to FIGS. 6A and 6B and FIGS. 7A and 7B, the following describes an abnormal-status display screen to be displayed on the display panel 98 as a result of the above-described abnormal-status display process.

The following describes a case where paper jams in a finisher with the display panel 98 displaying a remote panel. When the distance between the image forming apparatus 1 and the PDA apparatus 9 is equal to or larger than the threshold, the determination in S3 becomes Yes. As a consequence, the process of S4 is executed so that an abnormal-status display screen is displayed on the display panel 98 as shown in FIG. 6A. An outline of the abnormal status of the image forming apparatus 1 is displayed as like “Paper has jammed in the finisher.” in text on the abnormal-status display screen.

On the other hand, when the distance between the image forming apparatus 1 and the PDA apparatus 9 is smaller than the threshold upon occurrence of paper jam, the determination in S3 becomes No. This results in the execution of the process of S5. As a consequence, an outline of the abnormal status is displayed in text on the display panel 98 as shown in FIG. 6B. The displayed text is, for example, “Paper jams.” In addition, how to solve the paper jam is displayed in illustration and text on the abnormal-status display screen.

The following describes a case where toner is out with the display panel 98 displaying a remote panel. When the distance between the image forming apparatus 1 and the PDA apparatus 9 is equal to or larger than the threshold, the determination in S3 becomes Yes so that the process of S4 is executed. As a consequence, an outline of the abnormal status of the image forming apparatus 1 is displayed in text on the abnormal-status display screen as shown in FIG. 7A. For example, “Out of toner.” is displayed.

On the other hand, when the distance between the image forming apparatus 1 and the PDA apparatus 9 is smaller than the threshold upon occurrence of paper jam, the determination in S3 becomes No so that the process of S5 is executed. As a consequence, an outline of the abnormal status is displayed in text on the display panel 98 as shown in FIG. 7B. In this case, “Paper jams.” is also displayed. In addition, how to solve the toner shortage is displayed in illustration and text.

The above-described configuration can provide the following advantages.

A typical image forming system has a function of displaying an abnormal status of the image forming apparatus on the screen of a PDA apparatus. According to the typical art, however, when some abnormality occurs in the image forming apparatus, only an outline of the abnormal status of the image forming apparatus is displayed in text on a remote screen. Accordingly, while the abnormal status of the image forming apparatus can be grasped, an adequate display according to the positional relation between a user and the image forming apparatus cannot be provided.

As contrasted with the present disclosure, when some abnormality occurs in the image forming apparatus, the abnormal status of the image forming apparatus is displayed on the display panel of a PDA apparatus. At this time, the abnormal status is displayed with a display content according to the relative distance between the PDA apparatus and the image forming apparatus which is displayed on a remote panel. Therefore, an optimal display according to the distance between a user and the image forming apparatus can be presented automatically. As a result, this improves the usability of the user.

Specifically, according to this embodiment, an abnormal status of the image forming apparatus 1 is displayed on the display panel 98 with a display content according to the relative distance between the PDA apparatus 9 and the image forming apparatus 1 which is displayed on a remote panel. Therefore, an optimal display according to the distance between a user and the image forming apparatus can be presented automatically. As the result, the usability of the user is improved.

In addition, the foregoing description of the embodiment has been given of the case where the threshold of the distance between the image forming apparatus 1 and the PDA apparatus 9 is constant. However, the PDA apparatus 9 may include a threshold changing part that changes the threshold. In this case, the CPU 91 in the PDA apparatus 9 changes the threshold of the distance between the image forming apparatus 1 and the PDA apparatus 9 according to the operation of the PDA apparatus 9 under control of an operational application.

In addition, a method of specifying the distance between the image forming apparatus 1 and the PDA apparatus 9 is not limited to the use of GPS information. For example, the distance between the image forming apparatus 1 and the PDA apparatus 9 may be specified based on the intensity of radio waves.

Also, the foregoing description of the embodiment has been given of the case where the distance between the PDA apparatus 9 and the image forming apparatus 1 is not equal to or larger than the threshold. In that case, the foregoing description has been given of the case where how to solve the abnormal status of the image forming apparatus 1 is displayed on the display panel 98. When the distance between the PDA apparatus 9 and the image forming apparatus 1 is not equal to or larger than the threshold, however, a display more detailed than the outline of the abnormal status may be displayed on the display panel 98. Further, how to solve the abnormal status of the image forming apparatus 1 may display on the display panel 98.

The above-described configuration and operation of the embodiment are just illustrative, and may of course be modified as needed without departing from the scope and the purport of the present disclosure.

What is claimed is:

1. A personal digital assistant apparatus, comprising:
a distance calculating part that acquires positional information of an image forming apparatus and calculates a distance from the image forming apparatus;
a distance discriminating part that discriminates whether the distance calculated by the distance calculating part is equal to or greater than a threshold; and
an abnormal-status display part that displays an outline of an abnormal status of the image forming apparatus when the distance calculated by the distance calculating part is discriminated to be equal to or greater than the threshold and displays how to solve the abnormal status of the image forming apparatus when the distance calculated is discriminated to be smaller than the threshold.

2. The personal digital assistant apparatus according to claim 1, further including a threshold changing part that changes the threshold.

3. An abnormal-status displaying method for an image forming apparatus, including:
a positional-information acquisition step of acquiring positional information of the image forming apparatus;
a distance calculation step of calculating a distance from the image forming apparatus to a personal digital assistant apparatus based on the positional information acquired in the positional-information acquisition step and positional information of the personal digital assistant apparatus;
a distance discrimination step of discriminating whether the distance calculated in the distance calculation step is equal to or greater than a threshold;
an outline display step of displaying an outline of an abnormal status of the image forming apparatus on a screen of the personal digital assistant apparatus when the distance calculated in the distance calculation step is discriminated to be equal to or greater than the threshold; and
a details display step of displaying how to solve the abnormal status of the image forming apparatus on the screen of the personal digital assistant apparatus when the distance calculated in the distance discrimination step is discriminated to be smaller than the threshold.

4. The abnormal-status displaying method according to claim 3, further including a threshold changing step of changing the threshold.

5. A non-transitory recording medium having recorded therein a program for performing a computer to function as a personal digital assistant apparatus comprising:
a distance calculating part that acquires positional information of an image forming apparatus and calculates a distance from the image forming apparatus;
a distance discriminating part that discriminates whether the distance calculated by the distance calculating part is equal to or greater than a threshold; and
an abnormal-status display part that displays an outline of an abnormal status of the image forming apparatus when the distance calculated by the distance calculating part is discriminated to be equal to or greater than the threshold and displays how to solve the abnormal status of the image forming apparatus when the distance calculated is discriminated to be smaller than the threshold.

6. The recording medium according to claim 5, wherein the personal digital assistant apparatus further includes a threshold changing part that changes the threshold.
